(19) United States
(12) Patent Application Publication
(10) Pub. No.: US 2010/0271033 A1
(43) Pub. Date: Oct. 28, 2010

(54) OFF-VEHICLE COIL TESTER

(76) Inventor: Eudell Jennings Lusher, Kansas City, MO (US)

Correspondence Address: Hovey Williams LLP, 10801 Mastin Blvd., Suite 1000, Overland Park, KS, 66210, US

(21) Appl. No.: 12/765,167

(22) Filed: Apr. 22, 2010

Related U.S. Application Data
(60) Provisional application No. 61/173,493, filed on Apr. 28, 2009.

(51) Int. Cl. F02P 17/12

(52) U.S. Cl. 324/388

(57) ABSTRACT

A coil tester for testing the functionality of a vehicle ignition coil that has been removed from its vehicle includes a circuit that can be quickly and conveniently connected between the ignition coil and a battery so as to provide a current of sufficient voltage to the ignition coil. The coil tester also includes a momentary switch for preventing overheating of the ignition coil and a scale for indicating the strength of the coil.

### RELATED APPLICATIONS

This nonprovisional patent application claims priority benefit, with regard to all common subject matter, of earlier-filed U.S. provisional patent application titled “Off-Vehicle Coil Tester,” Ser. No. 61/173,493, filed Apr. 28, 2009. The identified earlier-filed application is hereby incorporated by reference in its entirety into the present application.

### BACKGROUND OF THE INVENTION

1. Field of the Invention

The present invention is concerned with a device for testing the functionality of ignition coils used in vehicles having gasoline-powered internal combustion engines such as automobiles, trucks, motorcycles, airplanes and boats. More particularly, it is concerned with a self-contained device which may be used with the coil removed from the vehicle to qualitatively test such coils.

2. Description of the Prior Art

Ignition coils are well-known devices which increase the voltage in an ignition circuit to enable a spark plug to produce a spark and thereby ignite the fuel-air mixture in a gasoline-powered internal combustion engine. In the past, a single ignition coil was connected to the vehicle battery, and a distributor served to intermittently and sequentially deliver current at an increased voltage to the spark plugs, thereby causing a spark to be produced across the gap between the electrodes of each spark plug. Such coils were reliable, rugged, and economical, and a single coil delivered the increased voltage to all of the spark plugs through their respective ignition wires. However, with the emergence of electronic ignitions and computer controls, the ignition coils heretofore known have largely been replaced by new ignition circuitry where individual coils are provided, and they may be mounted on the valve cover and a boot directly connects the ignition coil to one of the spark plug ignition wires, one for each plug. As a result, simply replacing all of the ignition coils of a vehicle has considerably increased in complexity, and the durability of their individual coils has been reduced, with failures much more common than in the past.

Consequently, repair shops confronted with servicing vehicles having ignition problems are still confronted with a need to first identify the nature of the problem and effect a repair. Most sensors now in use or available are ampere probes, which indicates whether current is passing through the coil but does not indicate quantitatively the output of the voltage of the coil. Elaborate computer diagnostic equipment is both expensive and is sometimes vehicle-specific, and even when available, may not function to detect faults in coils. Furthermore, it may be difficult to readily identify a problem involving insufficient voltage being provided by individual coils, and to assess which coil or coils are defective. In some instances, a coil may still provide sufficient voltage to provide a spark at higher engine speeds but not at low engine speeds or at start, making the diagnosis of the problem more difficult.

As a result, there has developed a need for a low-cost diagnostic device for an ignition coil which permits the coil to be tested off of the vehicle for satisfactory performance. Moreover, there has developed a need for such a device that is capable of providing information not only of whether current is passing through the coil but of the quality of the coil by providing quantitative testing results so that a mechanic can evaluate whether or not the coil is functioning acceptably.

### SUMMARY OF THE INVENTION

These and other needs have largely been met by the off-vehicle coil tester of the present invention. That is to say, the present invention provides an elegant, low-cost solution for determining whether or not a vehicle ignition coil, including those which are provided as part of individual spark plug ignition wires, is not only functioning, but is providing an acceptably high voltage to enable a spark plug to reliably deliver a spark, or whether the coil needs replacement.

Broadly speaking, the present invention includes an electrical circuit and a scale for measuring the strength of the voltage provided by the coil. The electrical circuit includes a terminal or grounding lug for connecting to leads, a capacitor, and an adapter or lead for coupling to a coil to be tested. The electrical circuit also preferably includes a switch, preferably a two-stage momentary switch, for selectively providing electrical power from a power source such as a battery to the terminal and capacitor and to the adapter or lead. The adapter is provided to readily connect the coil to be tested to the electrical circuit, but an electrically conductive lead having a clip may be substituted where the configuration of the coil to be tested varies. A grounding post is provided adjacent a modified spark plug connected by a spark plug receptacle to the coil to be tested, and the scale is located between the electrode of the spark plug and the grounding post. The scale is used as an indicator on the strength of the voltage at the spark plug electrode. The scale may be provided on a base or housing which mounts the switch and includes or mounts the scale and encloses the electrical circuit.

The invention hereof also includes a method for testing the coil. By connecting a power source such as a battery of a known voltage to the electrical circuit and electrically coupling the coil to be tested between the spark plug receptacle, the coil may be easily tested. The user actuates the switch to momentarily supply electricity to the capacitor and to the coil. This should produce a spark between the spark plug electrode and the grounding post if the coil is operating. By positioning the electrode adjacent the scale, the test can be repeated at different distances between the electrode and the grounding post to determine the voltage output, and thus the operating characteristics and performance, of the coil to be tested, with the coil removed from the vehicle.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing FIGURE.

### BRIEF DESCRIPTION OF THE DRAWING FIGURE

FIG. 1 is a schematic drawing of an off-vehicle coil tester in accordance with the present invention showing a coil to be tested as including a spark plug receptacle and the electrical circuit and the scale positioned adjacent or between the grounding post and the spark plug electrode.

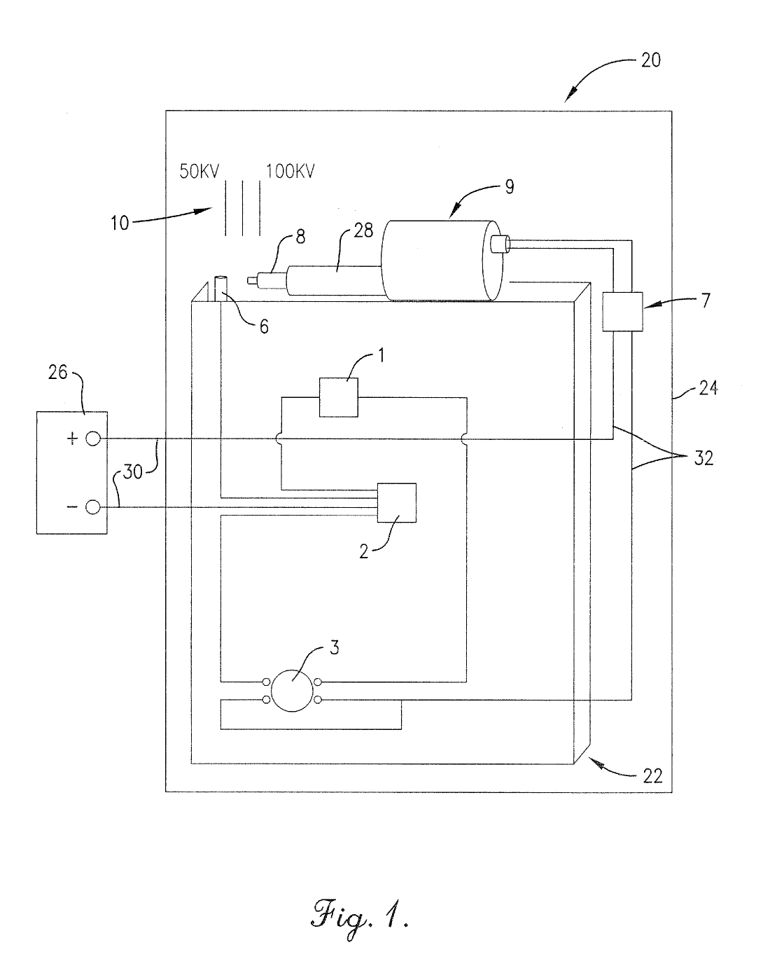

### DESCRIPTION OF THE PREFERRED EMBODIMENT

The following detailed description of embodiments of the invention references the accompanying drawing FIGURE. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled

Referring now to the drawing, an off-vehicle coil tester 20 in accordance with the present invention broadly includes an electrical circuit 22 and a scale 10. A base 24 or housing is provided to mount the electrical circuit 22 and scale 10. The coil tester 20 is configured for connection to a power source such as a battery 26 of known voltage, and to receive an ignition coil 9 to be tested.

In greater detail, the electrical circuit 22 includes leads or connectors 30 for connecting to battery 26, leads or connectors 32 for connecting to ignition coil 9, and circuitry electrically connected between the two sets of connectors. As most vehicle ignition coils operate on a 12 volt circuit, the battery 26 may be a conventional 12 volt automobile battery.

The connectors 30 and 32 may be wires, contacts, electrical leads, electrical clips, or any other electrically conductive devices. The connectors 32 may include or be connected to an adapter 7, which may be a pigtail adapter to permit connection to coils 9 of different configurations. The adaptor 7 is in turn electrically connected to the ignition coil 9 to be tested.

The circuitry electrically connected between the two sets of connectors 30, 32 may include a capacitor 1, a switch 3, and a ground lug or terminal 2. The ground or typically negative terminal of the battery 26 is electrically connected to the ground lug or terminal 2 which is electrically connected to the capacitor 1, to a grounding post 6, and to the switch 3.

The capacitor 1 may be of different values depending on the application, but a 33 millifarad capacitor has been found useful for most automotive applications in the present invention. The capacitor 1 is connected to the switch 3 as shown. The switch 3 is preferably a two stage momentary switch such as a push switch which provides a connection between the capacitor 1 and the ignition coil 9 to be tested only when actuated. The two-stage momentary switch 3 provides a connection to the capacitor 1 and the coil 9 without actuation, but only by activating the switch 3 is the circuit 22 closed to ground. It has been learned that if the capacitor 1 and coil 9 receive current for too long a period, for example 30 seconds, the coil becomes overheated and will not function properly. By providing the two-stage momentary switch 3, such overheating is avoided.

The circuit 22 also includes a grounding post 6 electrically connected to the negative terminal of the battery when the switch 3 is actuated. A spark plug receiver or boot 28 receives the test plug 8 for connection to the coil 9 to be tested. The test plug 8 is a modified conventional spark plug where the ground electrode (sometimes known as a side electrode or bottom electrode) has been removed, leaving only the center electrode.

The electrical circuit 22 and the scale 10 may be mounted on the base 24. Alternatively, the electrical circuit may be contained within a housing wherein the circuit is located within the housing and the switch 3 is mounted on the housing as is the adapter 7 for connecting to the coil 9, and the scale 10 is positioned adjacent to the grounding post. The connectors 32 may include clamps such as spring-loaded alligator clips for temporary connection between the switch 3 and the coil 9 if desired. Similarly, the connectors 32 may include electrical clamps for connecting the coil 9 and the boot or receiver for the test plug 8. The boot or receiver for the test plug 8 may be shiftably mounted to the base 24 or housing for movement closer to or farther away from the grounding post.

In use, the coil 9 to be tested is removed from the vehicle where it is typically bolted to the engine such as the engine valve cover, and connected to the circuit 22 of the tester by mounting to the adapter 7 configured to receive it, or to an electrical lead such as a pigtail connected to the negative side of the adapter. The tester 20 is then connected to the battery 26. The test plug 8 is positioned proximate the grounding post 6. The switch 3 is then actuated to momentarily ground the circuit and, if the coil 9 is operating, produce a spark between the central electrode of the test plug 8 and the grounding post 6. Different indicia or marks on the scale 10 indicate the strength of the coil 9. For example, if a spark is produced at a first, closer distance between the central electrode of the test plug 8 and the grounding post 6, the voltage through the coil would be at least 50 kV. If the test plug 8 is shifted so that the central electrode is now at a second mark farther away from the grounding post 6, the strength of the voltage through the coil would be at least 100 kV. As it may be appreciated, additional marks may be provided on the scale to indicate additional strengths, so that the mechanic can readily determine if the coil 9 is producing a sufficient voltage increase to provide a strong and adequate spark to the spark plugs of the vehicle even at low speeds. If the coil 9 is within limits, it is reinstalled, but if it is defective or deficient, it is replaced.

As a result of the present invention, a mechanic seeking to test ignition coils for their operating performance no longer has to use an automobile and have the coils tested when mounted to the automobile. The tests can be performed using any (typically 12 volt) battery source. The device 20 hereof includes a switch which avoids overheating of the coil 9. The device also includes an adapter 7 providing a convenient and readily mountable connection to the coil 9. In addition, the device 20 is not only economical and simple, but provides a scale for qualitatively testing the coil 9 according to the distance a spark is produced between the central electrode of a modified test plug 8 and a grounding post 6.

Although the invention has been described with reference to the preferred embodiment illustrated in the attached drawing FIGURE, it is noted that equivalents may be employed and substitutions made herein without departing from the scope of the invention as recited in the claims. Having thus described the preferred embodiment of the invention, what is claimed as new and desired to be protected by Letters Patent includes the following:

1. A tester for testing a vehicle ignition coil, the tester comprising:
a circuit including a first set of connectors for electrically connecting to a battery, a second set of connectors for electrically connecting to the ignition coil, and circuitry interposed between the first and second set of connectors for delivering current from the battery to the ignition coil; and
a scale operatively positioned relative to the circuit for indicating a strength of the ignition coil by measuring a gap across which a spark plug connected to the ignition coil produces a spark.

2. The tester of claim 1, wherein the circuitry includes a capacitor for storing energy from the battery and delivering a current of a sufficient voltage to the ignition coil.

3. The tester of claim 2, wherein the circuitry further includes a momentary switch electrically connected between the first and second sets of connectors for delivering current from the battery to the capacitor and the ignition coil only when manually activated.

4. The tester of claim 1, further comprising a spark plug receiver for receiving and connecting the spark plug to the ignition coil.

5. The tester of claim 4, further comprising a grounding post.

6. The tester of claim 5, wherein the spark plug receiver is configured to support the spark plug at selected distances from the grounding post.

7. The tester of claim 6, wherein the scale is configured to indicate a strength of the ignition coil by measuring a gap between the spark plug and the grounding post across which the spark plug produces a spark.

8. The tester of claim 7, wherein the scale indicates a relatively weaker strength for the ignition coil when the spark plug produces a spark across a relatively smaller gap and a relatively higher strength for the ignition coil when the spark plug produces a spark across a relatively larger gap.

9. The tester of claim 1, further comprising an adaptor for permitting the circuit to be electrically connected to ignition coils of various configurations.

10. The tester of claim 1, wherein the first and second sets of connectors comprise wires, contacts, electrical leads, or electrical clips.

11. A tester for testing a vehicle ignition coil, the tester comprising:
a support structure for supporting the ignition coil after it has been removed from its vehicle;
a circuit coupled with the support structure and including:
a first set of connectors for electrically connecting to a battery;
a second set of connectors for electrically connecting to the ignition coil;
a capacitor electrically connected between the first and second sets of connectors for storing energy from the battery and delivering a current of sufficient voltage to the ignition coil;
a switch electrically connected between the first and second sets of connectors for delivering current from the battery to the capacitor and ignition coil when activated;
a spark plug receiver for receiving and connecting a spark plug to the ignition coil; and
a scale operatively positioned relative to the spark plug receiver for indicating a strength of the ignition coil by measuring a gap across which the spark plug produces a spark.

12. The tester of claim 11, further comprising a grounding post supported on the support structure and electrically coupled with the circuit.

13. The tester of claim 12, wherein the spark plug receiver may be adjusted to support the spark plug at selected distances from the grounding post.

14. The tester of claim 13, wherein the scale is configured to indicate a strength of the ignition coil by measuring a gap between the spark plug and the grounding post across which the spark plug produces a spark.

15. The tester of claim 14, wherein the scale indicates a relatively weaker strength for the ignition coil when the spark plug produces a spark across a relatively smaller gap and a relatively higher strength for the ignition coil when the spark plug produces a spark across a relatively larger gap.

16. The tester of claim 11, further comprising an adaptor for permitting the circuit to be electrically connected to ignition coils of various configurations.

17. The tester of claim 11, wherein the first and second sets of connectors comprise wires, contacts, electrical leads, or electrical clips.

18. A tester for testing a vehicle ignition coil, the tester comprising:
a base for supporting the ignition coil after it has been removed from its vehicle;
a circuit coupled with the base and including:
a first set of connectors for electrically connecting to a battery;
a second set of connectors for electrically connecting to the ignition coil;
a capacitor electrically connected between the first and second sets of connectors for storing energy from the battery and delivering a current of sufficient voltage to the ignition coil;
a momentary switch electrically connected between the first and second sets of connectors for delivering current from the battery to the capacitor and ignition coil only when manually activated; and
a grounding post;
a spark plug receiver for receiving and connecting a spark plug to the ignition coil, the spark plug receiver being shiftable to support the spark plug at various distances from the grounding post; and
a scale operatively positioned relative to the spark plug receiver for indicating a strength of the ignition coil by measuring a gap across which the spark plug produces a spark.

19. The tester of claim 18, wherein the scale indicates a relatively weaker strength for the ignition coil when the spark plug produces a spark across a relatively smaller gap and a relatively higher strength for the ignition coil when the spark plug produces a spark across a relatively larger gap.

20. The tester of claim 18, further comprising an adaptor for permitting the circuit to be electrically connected to ignition coils of various configurations.
